(19) United States
(12) Patent Application Publication
(10) Pub. No.: US 2016/0292886 A1
(43) Pub. Date: Oct. 6, 2016

(54) APPARATUS AND METHOD FOR PHOTOGRAPHING PEOPLE USING A MOVABLE REMOTE DEVICE

(71) Applicants: Yariv ERAD, Kidron (IL); Menachem ERAD, Ashdod (IL)

(72) Inventors: Yariv ERAD, Kidron (IL); Menachem ERAD, Ashdod (IL)

(21) Appl. No.: 15/037,762

(22) PCT Filed: Nov. 27, 2014
(86) PCT No.: PCT/IL14/51033

§ 371 Date: May 19, 2016

Related U.S. Application Data
(60) Provisional application No. 61/911,081, filed on Dec. 3, 2013.

(51) Int. Cl. G06T 7/20; G06T 7/00; H04N 5/232; H04N 5/14

(52) U.S. Cl. CPC G06T 7/2093; H04N 5/144; G06T 7/004; H04N 5/23203; H04N 5/23296; G06T 2207/30244

(57) ABSTRACT

The subject matter discloses an image capturing device, comprising a tracking unit for tracking a user associated with the image capturing device, a positioning system for determining a position of the image capturing device to enable capturing an image of the user according to a photographing configuration and a movement mechanism to move the image capturing device to the position determined by the positioning system to conform with the photographing configuration.

### FIELD OF THE INVENTION

The invention generally relates to photographing a person using a movable camera.

### BACKGROUND OF THE INVENTION

There is a growing demand for mobile electronic devices, such as smartphone, tablets, phablets, laptops, ultra-light laptops, digital cameras, etc. One of the most common uses of all these devices is photographing. The improvement of the cameras in the mobile devices, along with the ability to upload the images and videos in higher quality to various web and cloud services, has created a growing trend of video and photo sharing application, such as Instagram, Flicker, Facebook, Pinterest, Snapchat, Vine, YouTube, etc. The main use of all these applications and services is to share photos and videos among friends and in a private/public manner.

One of the major trends in the field of photos sharing is known as “selfies”, i.e. photos taken by the person who appears in the photo. For that purpose, the users are making use of a front-facing camera in mobile electronic devices such as smartphones and Tablets—which are being produced with 2 camera—one on the screen side, and one on the device's back side. This enables the user to easily take photos of himself by moving the device and change the image properties while viewing the screen of the mobile electronic device.

Other camera manufacturers incorporate a swiveling display unit in the camera, using a dedicated bearing element so that the user can rotate the display unit towards himself and watch the content to be photographed while pointing the lens towards himself at the same time. Other solutions are more traditional in nature, and involve placing the camera away from the user, and to use a remote control device or a timer to trigger a photo capture, sometimes with the use of a tripod.

Yet, all these solutions are not optimal when it comes to self-taking photographing. Holding the device in the hand while using the front-facing camera or the rotatable display unit is limited by the arm length reach of the user, thus offering limited photographing options. In most cases, the taken photo is a frontal photo, and other angles of photographing are practically impossible.

In addition there are other devices that are equipped with a camera, and can be remotely controlled. For example, the Parrot flying drone is a quadricopter drone that is equipped with a camera, and can be controlled when flying via a dedicated application installed in a mobile device such as an iPod. The user can view via the mobile display at what the camera in the drone is pointed. However, the drone needs to be controlled and maneuvered by the user. Therefore, there is a need and desire to provide a system, method and device that can easily photograph the user of the device.

### SUMMARY OF THE INVENTION

The subject matter discloses an image capturing device, comprising a tracking unit for tracking a user associated with the image capturing device; a positioning system for determining a position of the image capturing device to enable capturing an image of the user according to a photographing configuration; a movement mechanism to move the image capturing device to the position determined by the positioning system to conform with the photographing configuration.

In some cases, the image capturing device further comprises a wireless receiver for receiving a command concerning adjusting the photographing configuration of the image capturing device. In some cases, the command is received via a module selected from a speaker, a messaging server, a signal from a remote location and a combination thereof.

In some cases, the image capturing device automatically moves responsive to detection of movement of the object photographed by the image capturing device. In some cases, the movement mechanism is a balancing mechanism for enabling the image capturing device to hover when tracking the object photographed by the image capturing device.

In some cases, the photographing configuration comprises a relative location of the image capturing device relative to the user. In some cases, the photographing configuration comprises a direction between the image capturing device and the user. In some cases, the photographing configuration comprises a specific area of the user.

In some cases, the tracking unit identifies the direction to which the user is looking and positions the image capturing device accordingly. In some cases, the tracking unit identifies a direction represented by a gesture performed by the user and positions the image capturing device accordingly. In some cases, the gesture is performed by an accessory.

In some cases, the photographing configuration is automatically adjusted according to a quality of a predefined parameter of images captured by the image capturing device in two or more positions of the image capturing device. In some cases, the photographing configuration comprises a predefined angle from the horizon.

In some cases, the image capturing device further comprises an automatic zoom module, wherein the automatic zoom module is automatically activated responsive to detection of movement of the object photographed by the image capturing device.

In some cases, the image capturing device further comprises an environmental sensor unit, wherein the position of the image capturing device is adjusted according to data collected by the environmental sensor unit. In some cases, the data collected by the environmental sensor unit comprises elements in the vicinity of the user photographed by the image capturing device.

In some cases, the photography is initiated according to a vocal command from a predefined person. In some cases, the photography is initiated according to a signal from a predefined electronic device. In some cases, the image capturing device is photographing two or more users according to the photographing configuration and prioritizing the photographing configuration of the two or more users.

In some cases, the image capturing device is transmitting the captured images to the two or more remote electronic device associated with the two or more users.

In some cases, the image capturing device comprises two or more cameras operating independently. In some cases, the two or more cameras are positioned to provide an image with a predefined combined configuration.

In some cases, the predefined combined configuration comprises coverage of the user photographed by the two or more cameras.

In some cases, a first camera of the two or more cameras is configured to capture images of a second camera of the two or more cameras and prevent the second camera from intersecting with obstacles. In some cases, the first camera is configured to send a command to the second camera if there is an obstacle between the second camera and the user photographed by the second camera according to the photographing configuration.

In some cases, the photographing configuration are adjusted to a second configuration responsive to an event. In some cases, the event is a signal sent from a remote electronic device to the image capturing device.

In some cases, the image capturing device communicates with a second movable image capturing device remotely communicating with the image capturing device, said second movable image capturing device is located in a different position relative to the user.

It is another object of the subject matter to disclose a method for capturing images of a user, comprising tracking the user over time using an image capturing device; determining a position of the image capturing device to enable capturing an image of the user according to a photographing configuration and moving the image capturing device to the position determined by the positioning system.

In some cases, the method further comprises receiving a command concerning adjusting the photographing configuration of the image capturing device. In some cases, the method further comprises identifying the direction to which the user is looking and positions the image capturing device accordingly.

In some cases, the method further comprises collecting data by an environmental sensor unit and adjusting the position of the image capturing device according to the collected data. In some cases, the method further capturing images of two or more users and prioritizing a first user of the two or more users over a second user of the two or more users. In some cases, the method further comprises detecting obstacles that prevent the camera from capturing images according to the predefined photographing configuration.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows components of the image capturing device, in accordance with a preferred embodiment of the invention;

FIGS. 2A and 2B show an image capturing device in front of a person and the image captured according to the predefined photographing configuration, according to exemplary embodiments of the subject matter;

FIGS. 3A and 3B show an image capturing device positioned aside from a person and the image captured according to the predefined photographing configuration, according to exemplary embodiments of the subject matter;

FIGS. 4A and 4B show an image capturing device positioned above a person and the image captured according to the predefined photographing configuration, according to exemplary embodiments of the subject matter;

FIGS. 5A and 5B show an image capturing device positioned in front of a person and the image captured according to the predefined opening angle, according to exemplary embodiments of the subject matter;

FIGS. 6A and 6B show an image capturing device positioned in front of a person and in the center of the person's body and the image captured according to a predefined photographing configuration, according to exemplary embodiments of the subject matter;

FIG. 7 shows an image capturing device moving from one position to another responsive to eye movement, according to exemplary embodiments of the subject matter;

FIG. 8 shows an image capturing device moving from one position to another responsive to a person's gesture, according to exemplary embodiments of the subject matter;

FIG. 9 shows an image capturing device moving from one position to another position responsive to a person's movements, according to exemplary embodiments of the subject matter;

FIG. 10 shows an image capturing device tracking a plurality of persons, according to exemplary embodiments of the subject matter;

FIG. 11 shows two image capturing devices tracking a person, according to exemplary embodiments of the subject matter;

FIG. 12 shows an operational environment of the image capturing device handling physical obstacles, according to exemplary embodiments of the subject matter;

FIG. 13 shows a user photographed in a crowded environment, according to a predefined photographing configuration, according to exemplary embodiments of the subject matter; and,

FIG. 14 shows a method of capturing images of a person according to a predefined photographing configuration, according to exemplary embodiments of the subject matter.

### DETAILED DESCRIPTION OF THE INVENTION

The present invention discloses an image capturing device for capturing images or video files of a person who is the user of the image capturing device according to a predefined photographing configuration. The photographing configuration may be inputted into the image capturing device by the person associated with the device, inputted by another person, or sent from a remote electronic device such as a smartphone or communication server. The image capturing device comprises a tracking unit for tracking the person associated with the photographing configuration, to enable the image capturing device to keep capturing images according to the same photographing configuration over time. The image capturing device also comprises a positioning system for determining a position of the image capturing device according to the photographing configuration. The positioning system may use information gathered from the tracking unit in order to determine the desired location of the image capturing device. The image capturing device also comprises a movement mechanism for moving the image capturing device to the position determined by the positioning system. The image capturing device also comprises a memory for storing the photographing configuration.

When creating the photographing configuration, the user may conduct a match-up process during the initialization stage of the Camera Device, in which a match is created between the image capturing device and the user. The match up process may include the creation of a unique image recognition ID or audio recognition ID of the user. Such match up process may include the creation of a unique eyes-based recognition ID of the user, or a unique ID data of the user, or include an ID for a remote electronic device associating with the image capturing device.

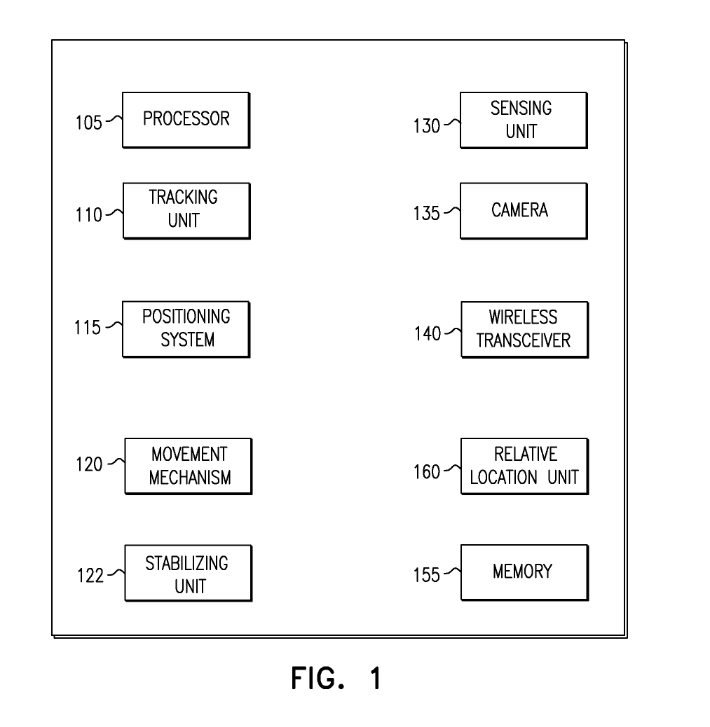

FIG. 1 shows components of the image capturing device, in accordance with a preferred embodiment of the invention. The image capturing device 100 may be used to take images and videos of a specific user, for example the owner of the image capturing device 100. The device 100 may be used to capture images of the user over time, for example while the user jogs, works, travels, drives, or hangs out in a party. The image capturing device captures images and videos of the user according to predefined photographing configuration inputted by the user, who is taking photos of himself or by another person. The photographing configuration may be updated via a signal from a remote device, such as the user's smartphone. The photographing configuration may update automatically according to a predefined set of rules or responsive to an event. For example, the image capturing device may focus on the user's face before 16:00 and capture the user's upper body after 16:00. The photographing configuration may be updated according to various parameters such as the person's location, time of the day, date, presence of other persons and the like.

The image capturing device 100 comprises a tracking unit 110 for tracking the user associated with the image capturing device. The tracking unit 110 is configured to detect the location and position of the user, or a predefined portion of the user, such as the user's head or the user's eyes. The tracking unit 110 may use an image or video acquired by the image capturing device in order find the user's location or orientation. In some exemplary cases, the user inputs the photographing configuration.

The image capturing device 100 further comprises a positioning system 115 for determining a position of the image capturing device 100 to enable capturing an image of the user according to the photographing configuration. For example, the photographing configuration may require the image capturing device to be 1.5 meters above the user's head or toes. In such a case, the tracking unit 110 finds the location of the relevant object in the user's body and the positioning system 115 determines the location of the image capturing device to be specific portion. In some other cases, the photographing configuration requires that the user's eyes are captured at a resolution of 2 mega pixels, which requires the image capturing device 100 to be located up to 320 centimeters from the user, according to the physical, computerized or electrical properties of the camera 135 of the image capturing device 100. The positioning system 115 may receive information from a surrounding environment sensing unit 130 to select the best position for the image capturing device 100. The sensing unit 130 may find obstacles in the vicinity of the user, or in the line of sight between the position determined by the positioning system 115 and the user. In such a case, the positioning system 115 may determine a secondary position for the image capturing device 100. A movement mechanism 120 of the image capturing device 100 is configured to move the image capturing device 100 to the position determined by the positioning system 115. The movement mechanism 120 may comprise a motor or a balancing mechanism to facilitate movement and optionally hovering above the user. The hovering mechanism may comprise a rotor, an electromagnetic unit, or any additional mechanism desired by a person skilled in the art. The movement mechanism 120 may be connected to a stabilizing unit 122 which enables the image capturing device to change its horizontal alignment. The movement mechanism 120 may be connected to a power source such as a battery, or activated using an independent power source such as a solar panel. The battery or solar panel may be integral in the image capturing device 100, or may be removable.

The image capturing device 100 also comprises a camera 135 for capturing images or videos of the user or an object determined by the user to be the essence of the image or video. Such object may be the user's cloth, or one meter in front of the user. In some exemplary cases, the image capturing device 100 comprises two or more cameras, one camera is used to capture images or videos according to the predefined photographing configuration, while another camera is used by the sensing unit 130, for example in order to locate obstacles. In some other cases, a third camera may be used to extract a relative location of the user, relative to the image capturing device 100. The image capturing device 100 may also comprise a relative location unit 160 for determining the location of the device relative to the photographed by the image capturing device. The relative location unit 160 may use RF, images, audio signals acquired by a microphone and the like. The relative location may be used by the positioning system 115 to locate the current location of the image capturing device 100, or find the correction required in order to move from the current location to a location that satisfies the photographing configuration.

The image capturing device 100 may also comprise a wireless transceiver 140 for receiving or transmitting information to or from a remote electronic device. Such information may be a command received from a user's mobile phone in which the user of the image capturing device 100 requests that no additional images should be captured, or that the photographing configuration should be amended. The user may use a menu or any other user interface displayed on the remote electronic device in order to change any photographing configuration used by the image capturing device 100. The wireless transceiver 140 may also be used to transmit information from the image capturing device 100 to a remote device, such as images and videos captured by the camera 135, metadata of those images and videos, confirmation of change of photographing configuration as inputted by the user of the remote device and the like.

The image capturing device 100 comprises a processor 105 for controlling the process of capturing images and videos according to the predefined photographing configuration. The processor 105 controls the components disclosed above. The image capturing device 100 may also comprise a motion estimation and motion compensation modules for compensating on the user's movement as well as the movements of the image capturing device 100 itself. The image capturing device 100 also comprises a memory 155 for storing the photographing configuration.

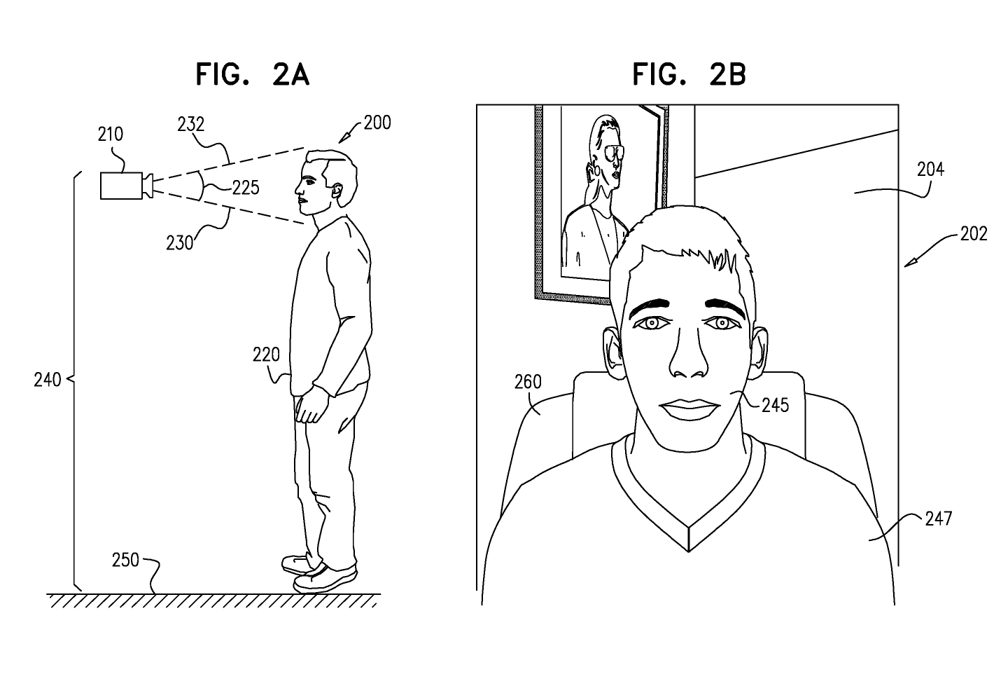

FIGS. 2A and 2B show an image capturing device in front of a user and the image captured according to the predefined photographing configuration, according to exemplary embodiments of the subject matter. In FIG. 2A, the image capturing device 210 is positioned in front of a user 200 according to the predefined photographing configuration stored in the image capturing device 210. The predefined configuration properties may define the height of the image capturing device 210, for example defined as a distance 240 between the image capturing device 210 and the ground 250. The predefined photographing configuration may also define the opening angle 225 in which the image is captured. The opening angle 225 may be defined between an upper borderline 232 and a lower borderline 230. The predefined photographing configuration may also define the distance between the image capturing device and the user 200, or between the image capturing device and a portion of the user or another item, such as the user's shirt 220. The predefined photographing configuration may also define which parts of the user 200 are to be captured. For example, the image 202 shown in FIG. 2B shows the user's face 245 and the user's shirt 247. The predefined photographing configuration may also define that only the top third of the shirt is to be captured. The image 202 also comprises a wall 204 behind the user's face 245 and a backrest 260 behind the user. In some exemplary cases, the image capturing device 210 comprises an automatic filtering unit for filtering elements captured in the image 202, for example the backrest 260. Such filtering may be done by background subtraction, or by any other technology desired by a person skilled in the art.

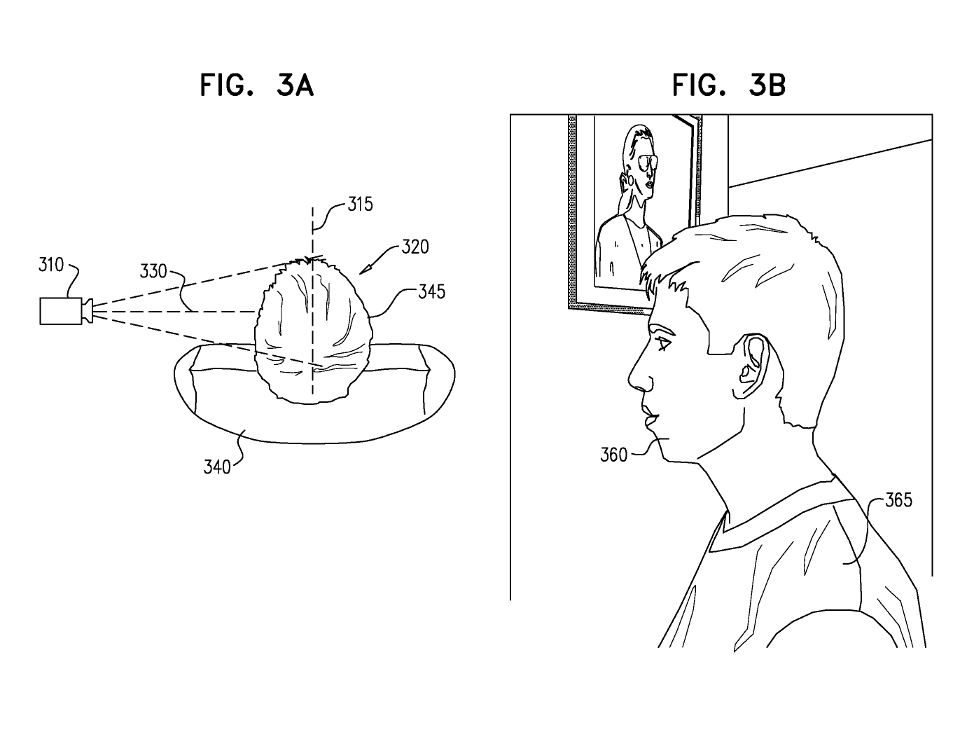

FIGS. 3A and 3B show an image capturing device positioned aside from a user and the image captured according to the predefined photographing configuration, according to exemplary embodiments of the subject matter. The image capturing device 310 is located at the user's side, such as the left hand side. The image capturing device 310 forms an angle of a predefined degree, such as 90 degrees between an imaginary frontal line 315 of the user 320 and the imaginary line 330 projected from the center of the image capturing device 310 towards the user 320. The opening angle of the image capturing device, both horizontally and vertically, defines which parts of the user 320 and the user's vicinity are to be captured in the image shown in FIG. 3B. The user's head 345 and the user's shirt 340 are shown only in part due to the position of the image capturing device 310 relative to the user 320. As such, in FIG. 3B it can be seen that only the left hand side 360 of the user's face is shown, as well as the left shoulder 365. In some exemplary cases, the location or position of the image capturing device 310 is adjusted responsive to movements of the user 320, using the tracking unit described above. As a result, in case the user 320 turns her face aside, the movement mechanism of the image capturing device 310 generates movement in order to move the image capturing device 310 to a location that enables capturing the image of the user 320 according to the predefined photographing configuration.

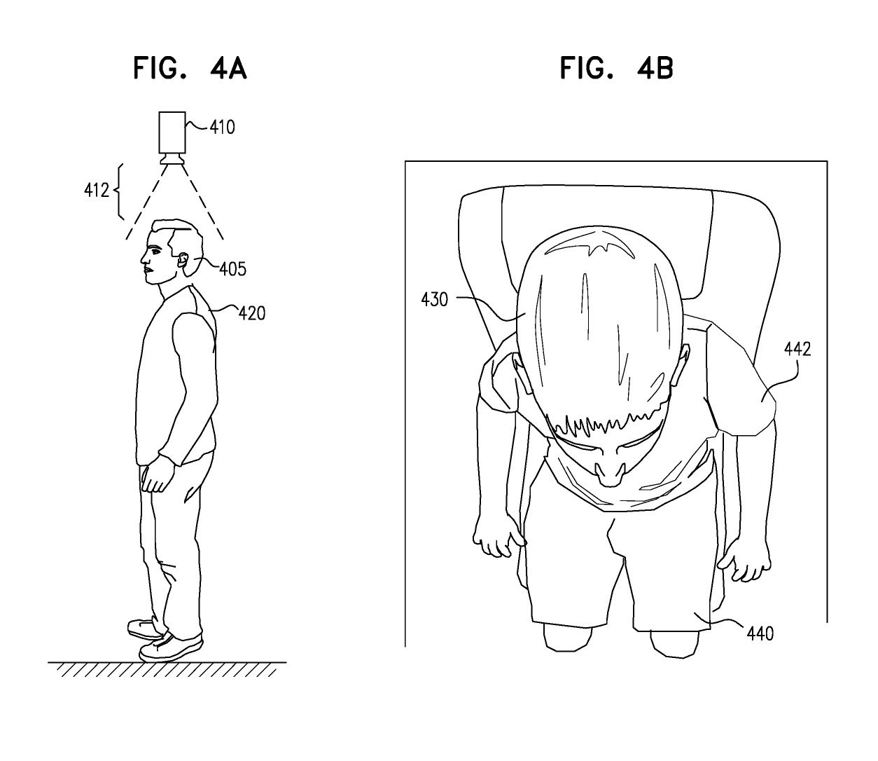

FIGS. 4A and 4B show an image capturing device positioned above a user and the image captured according to the predefined photographing configuration, according to exemplary embodiments of the subject matter. The image capturing device 410 is positioned over the user 405, at a distance 412 that satisfies the photographing configuration. The image capturing device 410 may hover over the user's head for a long time using a motor, rotor or engine that keeps the image capturing device 410 from falling to the ground. The image capturing device 410 also captures the user's shirt 420, as defined in the predefined photographing configuration. The image capturing device 410 is configured to capture a plurality of images over time according to the predefined photographing configuration. In some cases, an image is taken once every 5 seconds, for a period of 43 minutes, or until an occurrence of an event, such as sunset, or until a command from the user is received, via the wireless transceiver or a microphone of the image capturing device 410. The predefined photographing configuration may define that the image capturing device 410 is positioned 22 centimeters above the user's head. As such, when the user 405 sits, as shown in FIG. 4B, the user's trousers 440 are also included in the captured image, in addition to the user's head 430 and the user's shoulders 442.

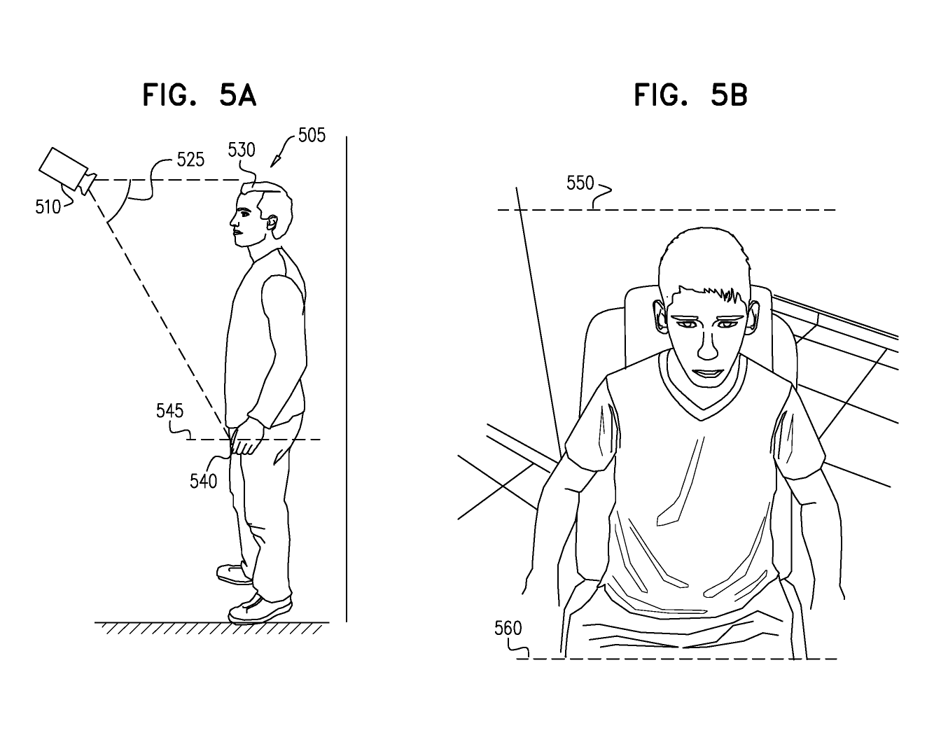

FIGS. 5A and 5B show an image capturing device positioned in front of a user and the image captured according to the predefined opening angle, according to exemplary embodiments of the subject matter. The image capturing device 510 captures an image of a user 505 according to the predefined opening angle 525. According to the example of FIG. 5A, the opening angle 525 is defined to capture the user 505 between the user's hair 530 and the user's waists 540. The predefined photographing configuration also defines that the image capturing device 510 is positioned at the height of the user's hair 530. In some other example, the opening angle 525 is defined to not include any elements located under imaginary line 545 that may represent a specific height. The imaginary line 545 is later converted to be the bottom borderline 560 of the image displayed in FIG. 5B, having also a top borderline 550.

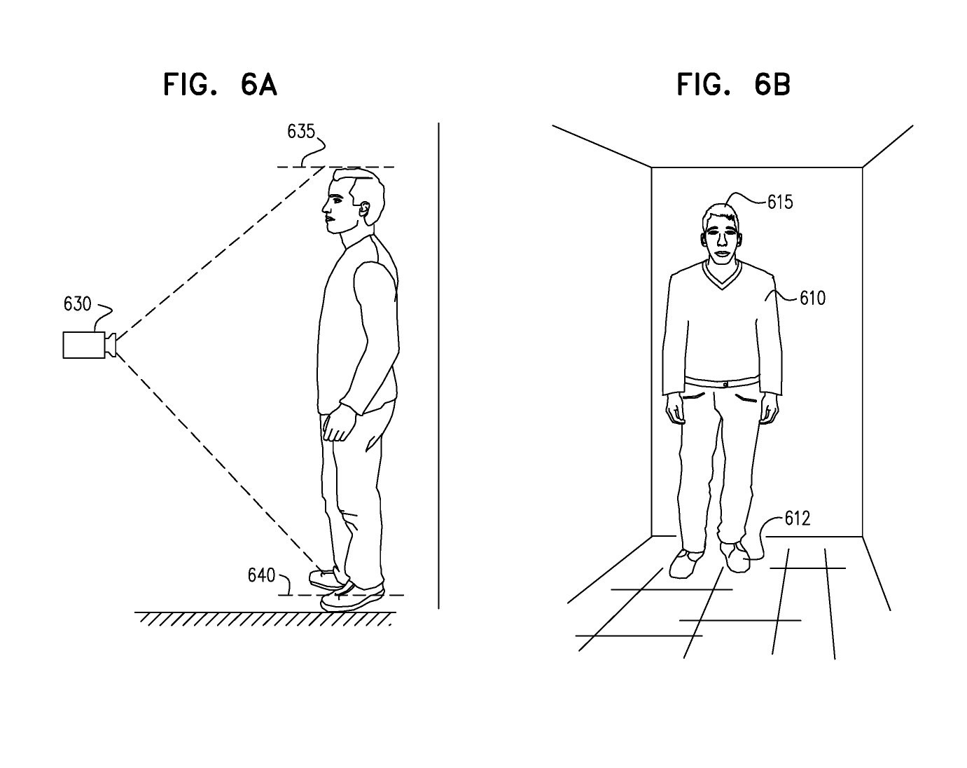

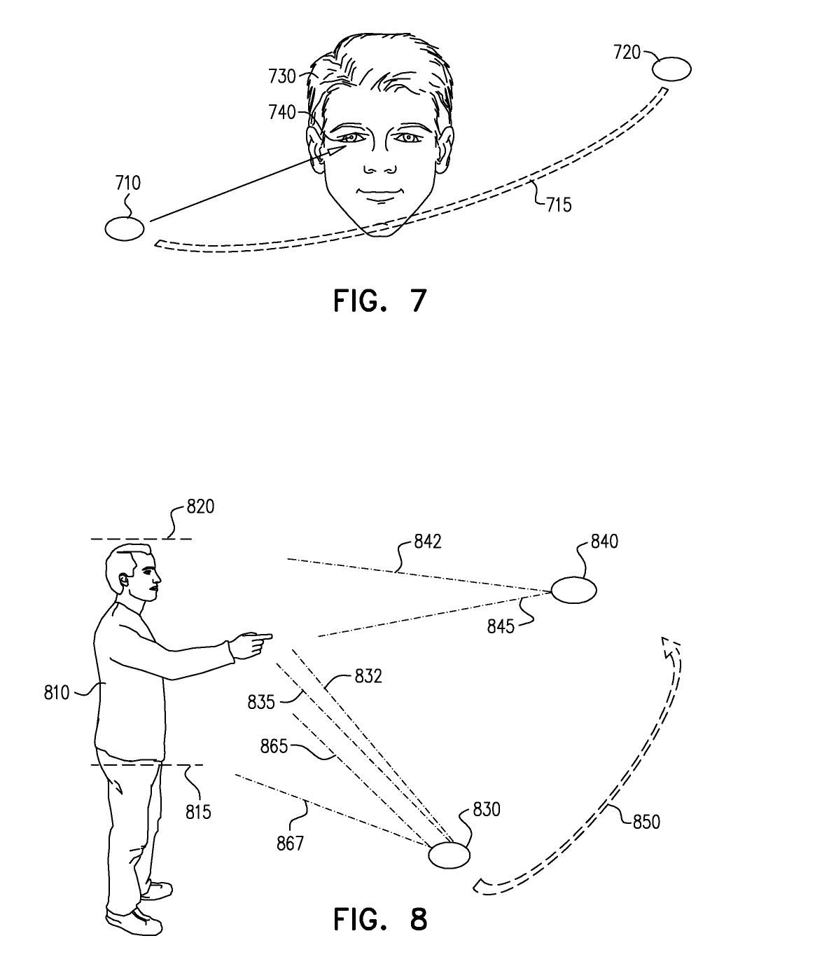

FIGS. 6A and 6B show an image capturing device positioned in front of a user and in the center of the user's body and the image captured according to a predefined photographing configuration, according to exemplary embodiments of the subject matter. In this exemplary embodiment, the image capturing device 630 is positioned by the positioning system in a height defined as the center between the user's hair 635 and the user's shoes or toes 640. The position of the image capturing device changes the image, as can be seen when comparing FIGS. 5B and 6B. FIG. 6B shows an image of the user 610, shown between the user's hair 615 and the user's shoes 612.

FIG. 7 shows an image capturing device moving from one position to another responsive to eye movement, according to exemplary embodiments of the subject matter. The image capturing device is located in a first location 710 and capturing images or videos of a user 730 according to the predefined photographing configuration. The image capturing device captures the direction at which the user's eyes 740 are directed and determines the location of the image capturing device accordingly. For example, when the user's eyes 740 look to the left, the image capturing device is moved to a second position 720 accordingly. The movement from the first position 710 to the second position 720 may be performed by the movement mechanism described above over a movement path 715.

FIG. 8 shows an image capturing device moving from one position to another responsive to a user's gesture, according to exemplary embodiments of the subject matter. The image capturing device is located at a first position 830, in which images or videos of the user 810 are taken according to a predefined photographing configuration. After some time, the image capturing device identifies a gesture performed by the user 810, for example via the user's finger 825 or limb. The image capturing device stores a set of rules, upon which the image capturing device is required to move to a second position 840 responsive to the predefined gesture made by the user 810. The movement from the first position 830 to the second position 840 may be performed by the movement mechanism described above over a movement path 850. When positioned in the second position 840, the image capturing device captures images and videos of the user 810 via an opening angle defined between upper borderline 842 and lower borderline 845.

The image capturing device may comprise two cameras, a first camera captures images to the user 810 between the user's head defined by virtual line 820 and the user's bottom line of the shirt, defined by virtual line 815. The first camera has an opening angle defined between virtual lines 865 and 863 when positioned in the first position 830. The second camera is directed towards a potential area of the predefined gesture, for example 30 centimeters ahead of the user's head. The second camera is directed to an area defined between virtual lines 832 and 835. In some cases, the gesture performed by the user 810 involves a physical element worn or held by the user 810, such as a ring, sticker, artificial nail and the like. The physical element may communicate with the image capturing device, for example via a QR code or a barcode. The image capturing device may track the physical element independently, in addition to tracking the user 810.

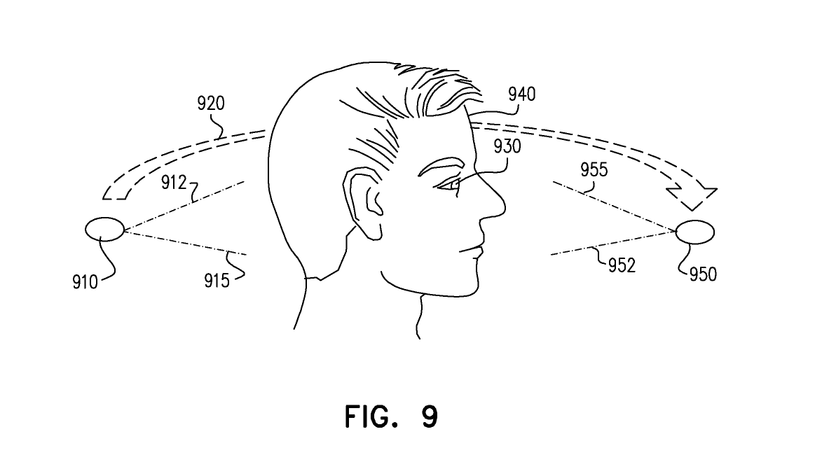

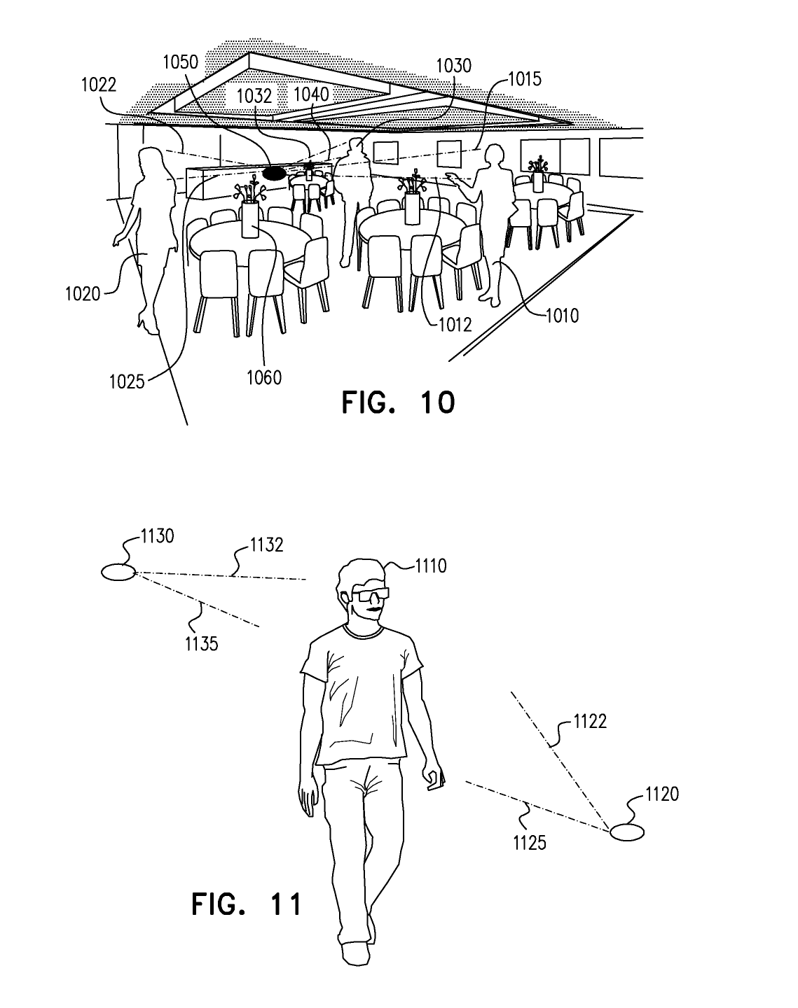

FIG. 9 shows an image capturing device moving from one position to another position responsive to a user's movements, according to exemplary embodiments of the subject matter. When the image capturing device is at the first position 910, the images or videos captured by the image capturing device is defined by virtual lines 912 and 915, according to the predefined photographing configuration stored at the memory of the image capturing device. The predefined photographing configuration dictates that the images should include at least a portion of the user's face that is two or more of the following elements: forehead 940, nose, mouth, left eye and right eye 930. Once the user moves her head to the other side, the predefined photographing configuration cannot be satisfied when the image capturing device is positioned at the first position. The tracking unit of the image capturing device recognizes that the user moved his head according to a predefined set of rules desired by a person skilled in the art. The movement mechanism generates movement of the image capturing device to a second position 950 that enables the image capturing device to capture images of the user that satisfy the predefined photographing configuration. The second position 950 is determined by the positioning unit of the image capturing device according to information extracted by the tracking unit, such the direction at which the user's head points, the distance between the image capturing device and the user's head and the like. The second position 950 may be determined according to presence of obstacles in the vicinity of the user, such as trees or walls, which forces the positioning unit to find an alternative position to the second position 950. In some cases, the obstacles may be identified by a second camera installed in the image capturing device, or via another image capturing device remotely communicating with the image capturing device of the present invention.

FIG. 10 shows an image capturing device tracking a plurality of persons, according to exemplary embodiments of the subject matter. The image capturing device 1050 is configured to track a first person 1010, a second person 1020 and a third person 1030. At least one of the three persons may be a user of the image capturing device. The first person 1010 is tracked between the upper line 1015 and bottom line 1012. The first person 1020 is tracked between the upper line 1022 and bottom line 1025. The first person 1030 is tracked between the upper line 1032 and bottom line 1040. The image capturing device 1050 may receive commands from one of the persons 1010, 1020 and 1030 to change the photographing configuration. In such case, the other persons will be notified via messages about the change in photographing configuration. The mage capturing device 1050 may capture images of the three persons serially, by rotating around itself, each time pointing to the relevant person. In some cases, one of the persons may be prioritized over the others, according to input sent to the mage capturing device 1050 or according to an objective parameter, such as brightness of the images captured when pointing the mage capturing device 1050 towards one of the persons. In some cases, an additional object 1060 may be added to the list of elements tracked and filmed by the mage capturing device 1050, for example for 10 minutes only, in a specific priority level. The priority level may indicate the quality of the images captured when pointing at the additional object 1060, or indicate whether it's a video or still image.

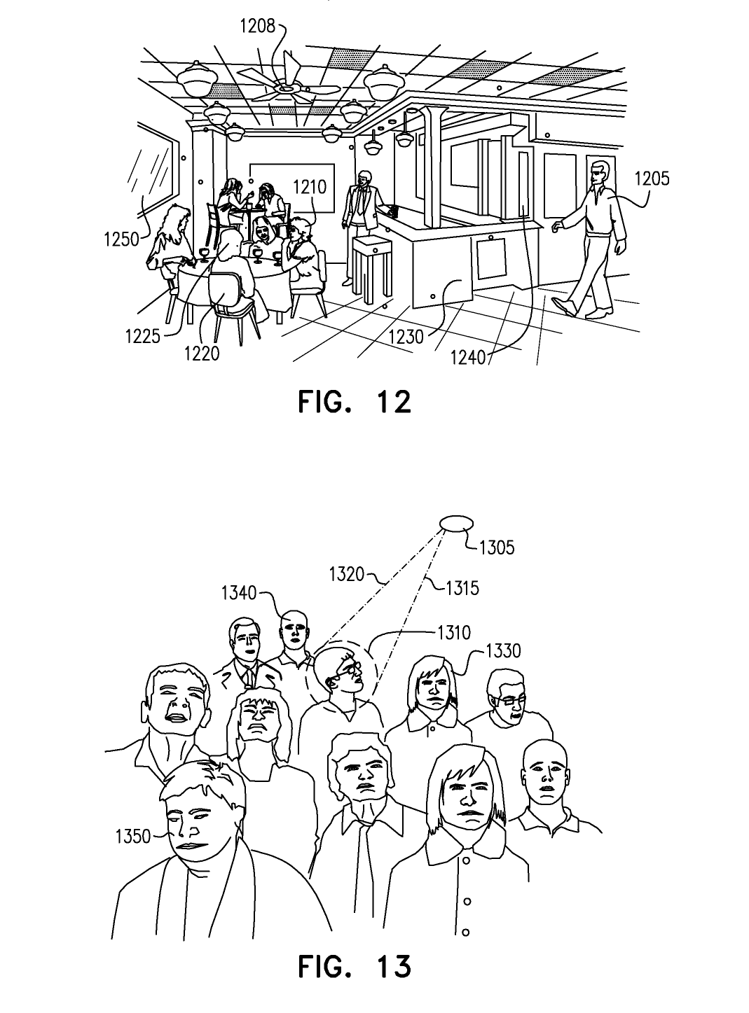

FIG. 11 shows two image capturing devices tracking a user, according to exemplary embodiments of the subject matter. A first image processing device 1130 is configured to capture the back side of the user's shirt, via an opening angle defined between top borderline 1132 and bottom borderline 1135. The back of the user's shirt may be helpful when the user is an athlete identified by a number in her back and the first image processing device 1130 keeps track of the athlete according to the number. The second image processing device 1120 captures images or video of the user's head 1110, according to the photographing configuration, for example defined between top borderline 1122 and bottom borderline 1125.

FIG. 12 shows an operational environment of the image capturing device handling physical obstacles, according to exemplary embodiments of the subject matter. The image capturing device of the subject matter is associated with a user 1210 sitting near a table with other persons, such as person 1225. In some cases, the image capturing device is configured by the user 1210 to capture images or videos of the user 1210 from 1.5-2 meters. However, the person 1225 sitting on a chair 1220 sits 2 meters in front of the user 1210 of the image capturing device and prevents the device from capturing images of the user 1210 according to the predefined photographing configuration. Thus, the image capturing device moves to a secondary position, which is 3 meters left of the user 1210. However, wall 1230 prevents the image capturing device from capturing images of the user 1210. A third position of the image capturing device cannot be used since light reflected from a window 1250 makes a property of the images such as brightness outside a requested range. Hence, the image capturing device is mounted above the user 1210, near the fan 1208. In some exemplary cases, the same image capturing device is configured to capture images of the user 1210 and of a secondary user 1205. In such a case, the image capturing device travels in the environment, looking for a position that can satisfy photographing configuration associated with both the user 1210 and the secondary user 1205. In some case, the user 1210 has a higher priority than the secondary user 1205, and the image capturing device can be positioned in a position that lacks a clean look of the secondary user, for example due to pole 1240.

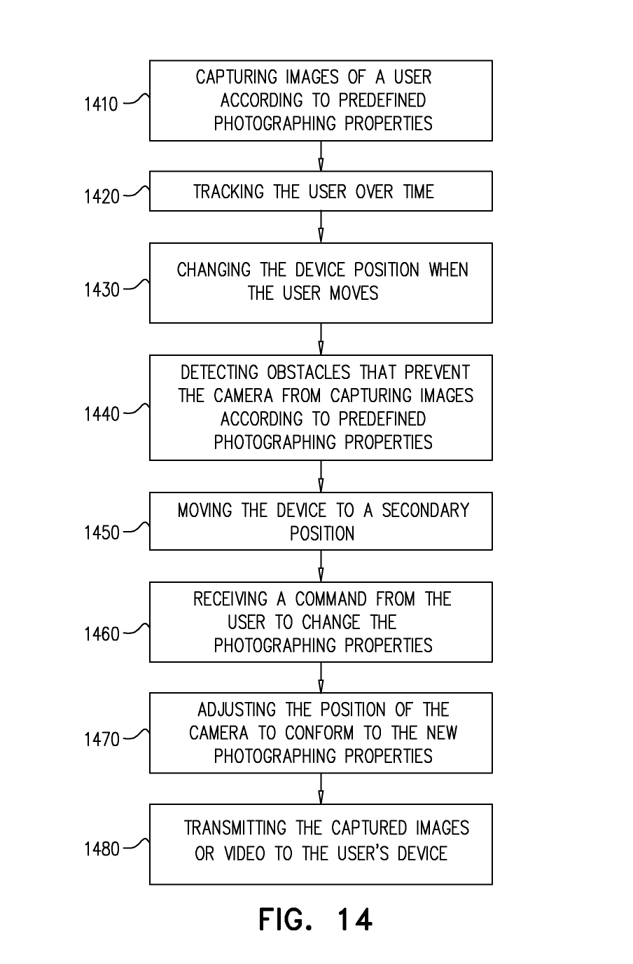

FIG. 13 shows a user photographed in a crowded environment, according to predefined photographing configuration, according to exemplary embodiments of the subject matter. The user 1310 is photographed by the image capturing device 1305 according to a predefined crowd mode. The crowd mode may be automatically activated when there are five (5) or more persons in the close vicinity of the user 1310. The crowd mode may dictate that only the user's face is captured, for example between lines 1315 and 1320. The crowd mode may dictate that the user is captured only when facing upwards, or only captured when person 1330 is distanced 0.5 meters from the user 1310. The crowd mode may allow capturing a video of the user 1310 only when a second person 1340 is also captured. In some other cases, the crowd mode may dictate that only when the user's face are turned downwards, such as person 1350, the user 1310 is captured, or the image capturing device moves to taking a video of the user 1310, not stills images.

FIG. 14 shows a method of capturing images of a user according to a predefined photographing configuration, according to exemplary embodiments of the subject matter. The method is performed at the image capturing device, and may involve the user's remote electronic device, two cameras installed in a single, image capturing device or another image capturing device communicating with the image capturing device in which the method is performed.

Step 1410 discloses capturing images of a user according to predefined photographing configuration. The image capturing devices may capture images or videos according to the configuration stored in the device, as well as responsive to a command from a remote device or a command detected by a microphone. The predefined photographing configuration may define the desired distance from the user, horizontal alignment of the camera, brightness, elements in the user's body or vicinity that have to be in the image or left out of the image and the like.

Step 1420 discloses tracking the user over time. Tracking the user may comprise extracting features associated with the user's position, movements, gestures, eye movements and the like, for example via a camera or more than one cameras. Tracking the user may comprise maintaining a calculation of the relative location of the image capturing device versus the person, for example using RF technologies, manipulations performed on images, audio signals and the like. The information extracted by the tracking unit is sent to the positioning unit to determine whether or not there is a need to move the image capturing device to a second position, for example, in order to conform to the predefined photographing configuration.

Step 1430 discloses changing the device position when the user moves. The image capturing device may move via a motor, hovering mechanism, a rotor and the like. The movement may be at a constant or variable height, speed, angle relative to the user and the like.

Step 1440 discloses detecting obstacles that prevent the camera from capturing images according to the predefined photographing configuration. The obstacle may be detected by a second camera included in the image capturing device, or using another device remotely connected to the image capturing device. The obstacle may be a person, a tree, a wall, a vehicle or any other object that prevents the image capturing device from taking an image according to the predefined photographing configuration.

Step 1450 discloses moving the device to a secondary position upon detection of the obstacle. In some cases, the storage of the image capturing device has a secondary location in which the device should be automatically placed in case an obstacle prevents an image to be captured at the best position. The secondary position may be defined by altitude and GPS location.

Step 1460 discloses receiving a command from the user to change the photographing configuration. The command may be sent from a remote device controlled by the user, such as a smartphone, for example via a text message or an adaptive user interface. The command may be reached at the image capturing device by a microphone.

Step 1470 discloses adjusting the position of the camera to conform to the new photographing configuration defined by the received command. The device's movement is described in step 1430.

Step 1480 discloses transmitting the captured images or video to the user's device. Transmission of the images or video files may be performed at batch mode or right after an image is captured. The transmission may be conditioned, for example according to network quality in the surroundings of the image capturing device.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An image capturing device, comprising:
a tracking unit for tracking a user associated with the image capturing device;
a positioning system for determining a position of the image capturing device to enable capturing an image of the user according to a photographing configuration;
a movement mechanism to move the image capturing device to the position determined by the positioning system to conform with the photographing configuration.

2. The image capturing device of claim 1, further comprises a wireless receiver for receiving a command concerning adjusting the photographing configuration of the image capturing device.

3. The image capturing device of claim 2, wherein the command is received via a module selected from a speaker, a messaging server, a signal from a remote location and a combination thereof.

4. The image capturing device of claim 1, wherein the image capturing device automatically moves responsive to detection of movement of the object photographed by the image capturing device.

5. The image capturing device of claim 1, wherein the movement mechanism is a balancing mechanism for enabling the image capturing device to hover when tracking the object photographed by the image capturing device.

6. The image capturing device of claim 1, wherein the photographing configuration comprises a relative location of the image capturing device relative to the user.

7. The image capturing device of claim 1, wherein the photographing configuration comprises a direction between the image capturing device and the user.

8. The image capturing device of claim 1, wherein the photographing configuration comprises a specific area of the user.

9. The image capturing device of claim 1, wherein the tracking unit identifies the direction to which the user is looking and positions the image capturing device accordingly.

10. The image capturing device of claim 1, wherein the tracking unit identifies a direction represented by a gesture performed by the user and positions the image capturing device accordingly.

11. The image capturing device of claim 10, wherein the gesture is performed by an accessory.

12. The image capturing device of claim 1, wherein the photographing configuration is automatically adjusted according to a quality of a predefined parameter of images captured by the image capturing device in two or more positions of the image capturing device.

13. The image capturing device of claim 1, wherein the photographing configuration comprises a predefined angle from the horizon.

14. The image capturing device of claim 1, further comprises an automatic zoom module, wherein the automatic zoom module is automatically activated responsive to detection of movement of the object photographed by the image capturing device.

15. The image capturing device of claim 1, further comprises an environmental sensor unit, wherein the position of the image capturing device is adjusted according to data collected by the environmental sensor unit.

16. The image capturing device of claim 15, wherein the data collected by the environmental sensor unit comprises elements in the vicinity of the user photographed by the image capturing device.

17. The image capturing device of claim 1, wherein initiating photography according to a vocal command from a predefined person.

18. The image capturing device of claim 1, wherein initiating photography according to a signal from a predefined electronic device.

19. The image capturing device of claim 1, wherein photographing two or more users according to the photographing configuration and prioritizing the photographing configuration of the two or more users.

20. The image capturing device of claim 19, wherein transmitting the captured images to the two or more remote electronic device associated with the two or more users.

21. The image capturing device of claim 1, wherein comprising two or more cameras operating independently.

22. The image capturing device of claim 21, wherein the two or more cameras are positioned to provide an image with a predefined combined configuration.

23. The image capturing device of claim 22, wherein the predefined combined configuration comprises coverage of the user photographed by the two or more cameras.

24. The image capturing device of claim 21, wherein a first camera of the two or more cameras is configured to capture images of a second camera of the two or more cameras and prevent the second camera from intersecting with obstacles.

25. The image capturing device of claim 24, wherein the first camera is configured to send a command to the second camera if there is an obstacle between the second camera and the user photographed by the second camera according to the photographing configuration.

26. The image capturing device of claim 1, wherein the photographing configuration are adjusted to a second configuration responsive to an event.

27. The image capturing device of claim 26, wherein the event is a signal sent from a remote electronic device to the image capturing device.

28. The image capturing device of claim 1, wherein communicating with a second movable image capturing device remotely communicating with the image capturing device, said second movable image capturing device is located in a different position relative to the user.

29. A method for capturing images of a user, comprising:
tracking the user over time using an image capturing device;
determining a position of the image capturing device to enable capturing an image of the user according to a photographing configuration;
moving the image capturing device to the position determined by the positioning system.

30. The method according to claim 29, further comprises receiving a command concerning adjusting the photographing configuration of the image capturing device.

31. The method according to claim 29, further comprises identifying the direction to which the user is looking and positions the image capturing device accordingly.

32. The method according to claim 29, further comprises collecting data by an environmental sensor unit and adjusting the position of the image capturing device according to the collected data.

33. The method according to claim 29, wherein capturing images of two or more users and prioritizing a first user of the two or more users over a second user of the two or more users.

34. The method according to claim 29, further comprises detecting obstacles that prevent the camera from capturing images according to the predefined photographing configuration.
